(19) United States
(12) Patent Application Publication
(10) Pub. No.: US 2010/0125713 A1
(43) Pub. Date: May 20, 2010

(54) DATA BACKUP SYSTEM AND DATA BACKUP METHOD THEREOF

(75) Inventors: Tao-Jun WU, Shanghai City (CN); Steve CHANG, Taipei County (TW); Yi-Min KAO, Taipei County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: INVENTEC APPLIANCES CORP., Taipei (TW)

(21) Appl. No.: 12/346,131

(22) Filed: Dec. 30, 2008

(30) Foreign Application Priority Data
Nov. 14, 2008 (TW) 097144119

(51) Int. Cl. G06F 12/16; G06F 12/00

(52) U.S. Cl. 711/162; 711/E12.001; 711/E12.103

(57) ABSTRACT

A data backup method is applicable to a cell phone with a data to be backed up stored therein. In the method, a timing instruction is first received to calculate a predetermined time period. Then, it is determined uninterruptedly whether the predetermined time period has elapsed. When the predetermined time period has elapsed, the data to be backed up is stored in a storage device.

### CROSS-REFERENCE TO RELATED APPLICATION

This application claims the benefit of Taiwan Patent Application No. 097144119, filed on Nov. 14, 2008, which is hereby incorporated by reference for all purposes as if fully set forth herein.

### BACKGROUND OF THE INVENTION

1. Field of the Invention

The present invention relates to a data backup system and a data backup method thereof, and more particularly to a data backup system and a data backup method thereof applicable to a cell phone.

2. Related Art

Currently, cell phones not only have communication functions such as making phone calls and sending/receiving short messages, but also provide diversified functions such as a contact list, a schedule, and a memo. Therefore, cell phones have been widely used by the mass and have become one of the important tools indispensable for modern life.

In view of the above, cell phones are usually provided with a built-in memory or a subscriber identity module (SIM) card, which is capable of storing most data such as the contact list, schedule, and memo therein.

However, when a cell phone or a SIM card is damaged, all the data such as the contact list, schedule, and memo are lost, and the user cannot read or use the data any more.

### SUMMARY OF THE INVENTION

Accordingly, the present invention is directed to a data backup method, which is capable of backing up a data stored in a cell phone.

The present invention is further directed to a data backup method, which is capable of saving a data in a cell phone.

The present invention is further directed to a data backup system, which is capable of saving a data in a cell phone.

The present invention is further directed to a data backup system, which is capable of executing the above data backup method.

One embodiment of the present invention provides a data backup method, which is adapted to a cell phone with a data to be backed up stored therein. The data backup method includes the following steps. First, a timing instruction is received to calculate a predetermined time period. Next, it is determined uninterruptedly whether the predetermined time period has elapsed. Then, when the predetermined time period has elapsed, the data to be backed up is stored in a storage device.

In an embodiment of the present invention, the storage device is an extended memory capable of being installed in a cell phone.

In an embodiment of the present invention, the extended memory is a memory card, an external hard disk, or a universal serial bus (USB) disk.

In an embodiment of the present invention, the storage device is a network server.

In an embodiment of the present invention, the process of storing the data to be backed up in the storage device further includes performing a format conversion on the data to be backed up into a data in a universal format, and then storing the data in the universal format in the storage device.

In an embodiment of the present invention, the process of storing the data to be backed up in the storage device further includes encrypting the data in the universal format during the format conversion.

In an embodiment of the present invention, the data backup method further includes decrypting the data in the universal format to generate a load data, and then storing the load data in the cell phone.

One embodiment of the present invention further provides a data backup method, adapted to the above cell phone, which includes the following steps. First, a timing instruction is received to calculate a particular time point. Next, it is determined uninterruptedly whether the particular time point is reached. Then, when the particular time point is reached, the data to be backed up is stored in a storage device.

One embodiment of the present invention further provides a data backup system, which includes a cell phone and a storage device. The cell phone has a data to be backed up stored therein and includes an input module and a timer. The input module is capable of inputting a timing instruction. The timer is capable of receiving the timing instruction to calculate a predetermined time period and determining uninterruptedly whether the predetermined time period has elapsed. The storage device is capable of storing the data to be backed up. Once the timer determines that the predetermined time period has elapsed, the data to be backed up is stored in the storage device.

In an embodiment of the present invention, the storage device is an extended memory capable of being installed in the cell phone.

In an embodiment of the present invention, the extended memory is a memory card, an external hard disk, or a universal serial bus (USB) disk.

In an embodiment of the present invention, the storage device is a network server.

In an embodiment of the present invention, the data backup system further includes a format converter, for performing a format conversion on the data to be backed up, so as to convert the data to be backed up into a data in a universal format and store the data in the universal format in the storage device.

In an embodiment of the present invention, the data backup system further includes an encryption unit. During the format conversion of the data to be backed up, the encryption unit encrypts the data in the universal format.

In an embodiment of the present invention, the data backup system further includes a decryption unit, for decrypting the data in the universal format, so as to convert the data in the universal format into a load data and store the load data in the cell phone.

The present invention further provides a data backup system, which includes a cell phone and a storage device. The cell phone has a data to be backed up stored therein and includes an input module and a timer. The input module is capable of inputting a timing instruction. The timer is capable of receiving the timing instruction to calculate a particular time point, and determining uninterruptedly whether the particular time point is reached. The storage device is capable of storing the data to be backed up. Once the timer determines that the particular time point is reached, the data to be backed up is stored in the storage device.

In an embodiment of the present invention, the storage device is an extended memory capable of being installed in the cell phone.

In an embodiment of the present invention, the extended memory is a memory card, an external hard disk, or a universal serial bus (USB) disk.

In an embodiment of the present invention, the storage device is a network server.

In an embodiment of the present invention, the data backup system further includes a format converter, for performing a format conversion on the data to be backed up, so as to convert the data to be backed up into a data in a universal format and store the data in the universal format in the storage device.

In an embodiment of the present invention, the data backup system further includes an encryption unit. During the format conversion of the data to be backed up, the encryption unit encrypts the data in the universal format.

In an embodiment of the present invention, the data backup system further includes a decryption unit, for decrypting the data in the universal format, so as to convert the data in the universal format into a load data and store the load data in the cell phone.

The present invention enables a cell phone to back up a data automatically once a predetermined time period has elapsed or a particular time point is reached through a timing instruction. Thus, the data originally stored in the cell phone can be saved according to the present invention.

### BRIEF DESCRIPTION OF THE DRAWINGS

The present invention will become more fully understood from the detailed description given herein below for illustration only, which thus is not limitative of the present invention, and wherein:

FIG. 1 is a schematic view of devices in a data backup system according to an embodiment of the present invention.

FIG. 2A is a flow chart of a data backup method according to an embodiment of the present invention.

FIG. 2B is a flow chart of a process of storing a data to be backed up in a storage device in FIG. 2A.

FIG. 2C is a flow chart of a process of downloading a data in a universal format in FIG. 2B.

FIG. 3 is a flow chart of a data backup method according to another embodiment of the present invention.

### DETAILED DESCRIPTION OF THE INVENTION

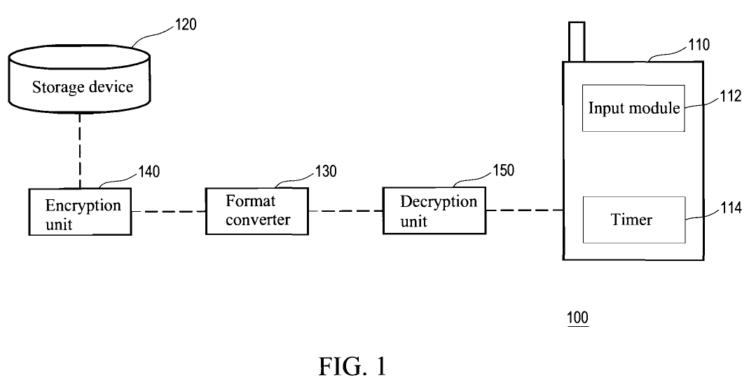

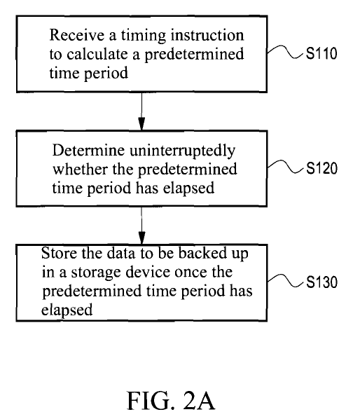

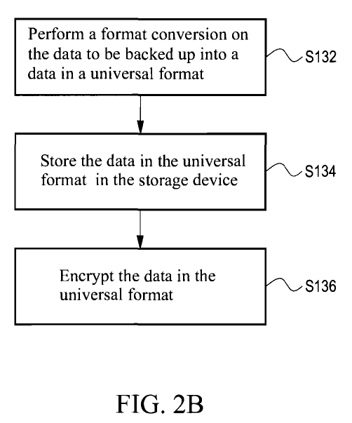

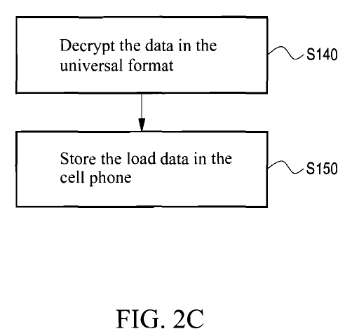

FIG. 1 is a schematic view of devices in a data backup system according to an embodiment of the present invention, and FIG. 2A is a flow chart of a data backup method according to an embodiment of the present invention. Referring to FIGS. 1 and 2A, a data backup system 100 includes a cell phone 110 and a storage device 120. The cell phone 110 includes an input module 112 and a timer 114. The data backup method in this embodiment is applied in the cell phone 110 in which a data to be backed up has been stored therein. The data to be backed up may include data such as a contact list, a schedule, and a memo.

The cell phone 110 here generally refers to a portable electronic apparatus with functions of making phone calls and capable of offering internet services, such as a personal digital assistant phone (PDA phone), a smart phone, or a wireless application protocol phone (WAP phone).

In the data backup method, firstly, the timer 114 receives a timing instruction to calculate a predetermined time period (S110). The timing instruction is input via the input module 112 and is generated by a user through manipulating the input module 112. Thus, the input module 112 is capable of inputting a timing instruction, and the timer 114 is capable of receiving the timing instruction.

Particularly, when the user has decided the predetermined time period, the user manipulates the cell phone 110 to input a timing instruction via the input module 112, and then, the timer 114 calculates a predetermined time period based on the received timing instruction. Depending upon the user's demands, the predetermined time period may be one day, one week, one month, or half a year.

Once the predetermined time period has been calculated, the timer 114 determines uninterruptedly whether the predetermined time period has elapsed (S120). For example, the timer 114 starts counting the time at this time and keeps counting without interruption, so as to learn the time elapsed since the predetermined time period was calculated. As such, the timer 114 can determine whether the predetermined time period has elapsed. As can be known, the above steps of receiving the timing instruction to calculate a predetermined time period (S110) and determining uninterruptedly whether the predetermined time period has elapsed (S120) can be performed through the timer 114.

Once the predetermined time period has elapsed, the data to be backed up is stored in the storage device 120 (S130). The storage device 120 may be an extended memory. That is, the data to be backed up may be stored in the extended memory for backup. Furthermore, the extended memory can be installed in the cell phone 110.

Particularly, the extended memory refers to a memory additionally installed in the cell phone 110 for expanding the memory capacity, which is, for example, a memory card, an external hard disk, or a universal serial bus (USB) disk. Thus, the extended memory is not a built-in memory or a SIM card of the cell phone 110. Furthermore, the memory card is, for example, a secure digital card (SD card) or a memory stick (MS).

In view of the above, in this embodiment, the user can set a predetermined time period before hand and instruct the data in the cell phone 110 such as a contact list, a schedule, and a memo to be automatically backed up in the extended memory once every certain time period (i.e., the predetermined time period) such as every other day, every other week, or every other month.

As such, once the cell phone 110 or the SIM card is damaged, the user can take out the extended memory and read the data backed up in the extended memory through a computer or another cell phone. Thus, in this embodiment, the data originally stored in the cell phone 110 such as the contact list, the schedule, and the memo can be saved, so that the user can still use and read the data.

Besides, the storage device 120 may be a network server. Particularly, the cell phone 110 may communicate with a base station, and the base station communicates with the network server. Accordingly, the cell phone 110 can upload the data to be backed up to the network server through the base station. That is, the network server can store the data to be backed up. In other words, this embodiment further enables the data in the cell phone 110 such as the contact list, the schedule, and the memo to be automatically backed up in the network server once every certain time period (i.e., the predetermined time period).

In view of the above, even if the cell phone 110 or the SIM card is damaged, or what's worse, if the cell phone 110 is lost, the user can still read the data originally stored in the cell phone 110 such as the contact list, the schedule, and the memo from the network server. Furthermore, the user can also download the data to a computer or another cell phone. In this way, the user can continue to use the data.

It should be noted that, the step of storing the data to be backed up in the storage device 120 can be performed through a background program in this embodiment. Particularly, while the cell phone 110 is storing the data to be backed up in the storage device 120, the user can still use the cell phone 110 normally. For example, even though the cell phone 110 is performing the step of storing the data to be backed up, the user can still normally use the cell phone 110 to answer phone calls, make phone calls, send short messages, or play games.

FIG. 2B is a flow chart of a process of storing a data to be backed up in a storage device in FIG. 2A. Referring to FIGS. 1 and 2B, the data backup system 100 further includes a format converter 130. In the process of storing the data to be backed up in the storage device 120, firstly, the format converter 130 performs a format conversion on the data to be backed up, so as to convert the data to be backed up into a data in a universal format (S132). Then, the data in the universal format is stored in the storage device 120 (S134).

In view of the above, the format conversion is mainly a conversion of a file format of the data to be backed up, without changing the original contents of the data to be backed up. That is to say, the contents of the data in the universal format are actually the same as that of the data to be backed up, such as the contact list, the schedule, and the memo.

The data in the universal format can be read by a common electronic apparatus such as an ordinary home computer, a PDA, or a notebook computer. That is to say, the data in the universal format has superior compatibility and portability. Therefore, the user can easily read the contents of the data in the universal format. For example, the data in the universal format can be directly read through Microsoft window operating system (Microsoft Window OS) or Mac operating system (Mac OS).

It should be noted that, the data backup system 100 further includes an encryption unit 140. During the format conversion, the encryption unit 140 encrypts the data in the universal format (S136). Particularly, as the data in the universal format can be read by a common electronic apparatus such as an ordinary home computer, a PDA, or a notebook computer, any one can easily read the contents of the data in the universal format, so that data such as the contact list, the schedule, and the memo can be easily stolen. Therefore, the data in the universal format is turned into an encrypted status through being encrypted in this embodiment, so as to prevent the data from being stolen.

FIG. 2C is a flow chart of a process of downloading a data in a universal format in FIG. 2B. Referring to FIGS. 1 and 2C, the data backup system 100 further includes a decryption unit 150. After the data in the universal format is stored in the storage device 120, when the user wants to download the data in the universal format, the decryption unit 150 decrypts the data in the universal format (S140) to generate a load data.

Thereafter, the load data is stored in the cell phone 110 (S150), and the load data may be download to the cell phone 110 from the extended memory or the network server. For example, if the load data is downloaded from an extended memory, the user firstly installs the extended memory in the cell phone 110. Once the extended memory is installed in the cell phone 110, the load data is automatically saved in the built-in memory or the SIM card of the cell phone 110 through software or firmware.

Of course, once the extended memory is installed in the cell phone 110, the user may also manipulate the cell phone 110 to decide whether to store the load data or not. Therefore, in this embodiment, the load data may be automatically stored in the cell phone 110 or passively stored in the cell phone 110 in a non-automatic manner.

Furthermore, if the load data is downloaded from the network server, the user may manipulate the cell phone 110 or a computer to send a download request to the network server. According to the download request, the network server enables the cell phone 110 to download the load data.

Particularly, the user may, for example, log in the network server using a computer or the cell phone 110, in which the user is required to type in an account and a password. Then, the user sends a download request to the network server using the computer or the cell phone 110. Then, according to the download request, the network server transmits the load data to a cell phone specified by the user, in which the network server gets to know the cell phone specified by the user based on a number of the cell phone.

It should be noted that, both the encryption process (S136) in FIG. 2B and the decryption process (S140) in FIG. 2C are merely optional steps in this embodiment. That is, the encryption and decryption processes may be omitted in this embodiment. Accordingly, the above encryption and decryption processes are merely taken as examples, but not intended to limit the present invention.

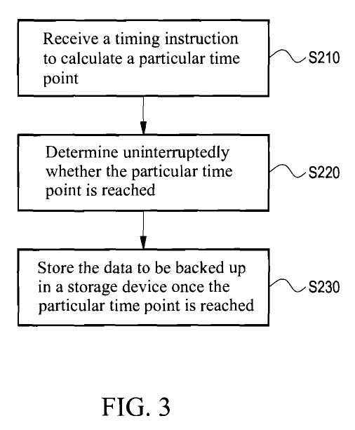

FIG. 3 is a flow chart of a data backup method according to another embodiment of the present invention. Referring to FIGS. 1 and 3, a data backup method in this embodiment is also applied in the cell phone 110 shown in FIG. 1, which is similar to the data backup method in the embodiment described above. Accordingly, the following description focuses on the differences between the two embodiments and a detailed description is made below with reference to FIG. 1.

In this embodiment, firstly, the timer 114 receives a timing instruction to calculate a particular time point (S210). The timing instruction is generated by a user through manipulating the input module 112. That is, the timing instruction is input via the input module 112. Particularly, once the user decides the particular time point, the user manipulates the cell phone 110 to generate a timing instruction, and according to the timing instruction, the cell phone 110 calculates the particular time point.

In view of the above, the particular time point refers to a particular point of time, such as a certain time of a day (e.g., 12:00 AM), a day of a week (e.g., Saturday), a day of a month (e.g., the first day of a month), or a day of a year (e.g., a festival such as New Year's Day or mid-autumn festival).

Once the particular time point is calculated, the timer 114 determines uninterruptedly whether the particular time point is reached (S220). For example, a screen (not shown) of the cell phone 110 displays a current time, and once receiving the timing instruction, the timer 114 calculates the particular time point and determines uninterruptedly whether the particular time point is reached or not based on the current time. Particularly, once the current time displayed is the particular time point, the timer 114 determines that the particular time point is reached.

Once the particular time point is reached, the data to be backed up is stored in the storage device 120 (S230). The storage device 120 may be an extended memory or a network server, and the extended memory may be, for example, a memory card, an external hard disk, or a universal serial bus (USB) disk.

As known from the above, in this embodiment, the user may set a particular time point in advance, so that all the data in the cell phone 110 such as the contact list, the schedule, and the memo are automatically backed up in the extended memory or the network server at the particular time point.

For example, the user may set the cell phone 110 to automatically store the data to be backed up in the extended memory or the network server at 12:00 PM on the 15^{th} day of the next month. Besides, the user may alternatively set the cell phone 110 to automatically store the data to be backed up in the extended memory or the network server at 11:00 PM on the 10^{th} day of every month. As such, the cell phone 110 backs up the data once every month.

Besides, in this embodiment, the data to be backed up may also be stored in the extended memory or the network server through a background program. In other words, the user can still use the cell phone 110 normally while the cell phone 110 is storing the data to be backed up in the storage device 120.

In addition, in the step of storing the data to be backed up in the storage device 120, the process illustrated in FIG. 2B may also be adopted in this embodiment. That is, when the data to be backed up is stored in the storage device 120 (S230), the format converter 130 may perform a format conversion (i.e., S132 of FIG. 2B) and the encryption unit 140 may perform an encryption process (i.e., S136 of FIG. 2B), thereby preventing the data from being stolen.

Furthermore, when the user wants to download the data to be backed up, the process illustrated in FIG. 2C may be adopted in this embodiment. That is, the decryption unit 150 decrypts the data in the universal format to generate a load data. Therefore, the data backup method of this embodiment may also employ the techniques disclosed in FIGS. 2B and 2C.

To sum up, through the timing instruction, the present invention enables the cell phone to back up the data once a predetermined time period has elapsed or a particular time point is reached. That is to say, the data in the cell phone is automatically backed up once every certain time period (e.g., every day or every week) or at a particular point of time (e.g., a certain day of a month, or a festival such as New Year's Day or mid-autumn festival) according to the present invention. As such, even if the cell phone or the SIM card is damaged, the data originally stored in the cell phone can be saved, so that the user can still use the data according to the present invention.

Besides, the data originally stored in the cell phone can be further backed up in the network server according to the present invention. Thus, even if the cell phone is lost, the user can still read the data originally stored in the cell phone from the network server and further download the data to a computer or another cell phone, so that the data can still be used or read.

Additionally, when the data to be backed up is stored in the storage device, a format conversion may be further performed to convert the data to be backed up into a data in a universal format according to the present invention. The data in the universal format can be read by a common electronic apparatus such as an ordinary home computer, a PDA, or a notebook computer. In this way, the user can easily read the data in the universal format.

Furthermore, the data in the universal format can be further encrypted according to the present invention. Therefore, the data in the universal format can be turned into an encrypted status in the present invention, so that the data originally stored in the cell phone such as the contact list, the schedule, and the memo is protected from being stolen.

The above embodiments are merely intended to describe the technical solutions of the present invention, but not to limit the scope of present invention. It will be apparent to those skilled in the art that various modifications and variations can be made to the structure of the present invention without departing from the scope or spirit of the invention.

What is claimed is:

1. A data backup method, adapted to a cell phone with a data to be backed up stored therein, the method comprising:
receiving a timing instruction to calculate a predetermined time period;
determining uninterruptedly whether the predetermined time period has elapsed; and
storing the data to be backed up in a storage device when the predetermined time period has elapsed.

2. The data backup method according to claim 1, wherein the storage device is an extended memory capable of being installed in the cell phone.

3. The data backup method according to claim 2, wherein the extended memory is a memory card, an external hard disk, or a universal serial bus (USB) disk.

4. The data backup method according to claim 1, wherein the storage device is a network server.

5. The data backup method according to claim 1, wherein the storing the data to be backed up in the storage device further comprises:
performing a format conversion on the data to be backed up to convert the data to be backed up into a data in a universal format; and
storing the data in the universal format in the storage device.

6. The data backup method according to claim 5, wherein the storing the data to be backed up in the storage device further comprises:
encrypting the data in the universal format during the format conversion.

7. The data backup method according to claim 6, wherein after storing the data to be backed up in the storage device, the method further comprises:
decrypting the data in the universal format to generate a load data; and
storing the load data in the cell phone.

8. A data backup method, adapted to a cell phone with a data to be backed up stored therein, the method comprising:
receiving a timing instruction to calculate a particular time point;
determining uninterruptedly whether the particular time point is reached; and
storing the data to be backed up in a storage device when the particular time point is reached.

9. The data backup method according to claim 8, wherein the storage device is an extended memory capable of being installed in the cell phone.

10. The data backup method according to claim 9, wherein the extended memory is a memory card, an external hard disk, or a universal serial bus (USB) disk.

11. The data backup method according to claim 8, wherein the storage device is a network server.

12. The data backup method according to claim 8, wherein the storing the data to be backed up in the storage device further comprises:
performing a format conversion on the data to be backed up to convert the data to be backed up into a data in a universal format; and
storing the data in the universal format in the storage device.

13. The data backup method according to claim 12, wherein the storing the data to be backed up in the storage device further comprises:
encrypting the data in the universal format during the format conversion.

14. The data backup method according to claim 13, wherein after storing the data to be backed up in the storage device, the method further comprises:
decrypting the data in the universal format to generate a load data; and
storing the load data in the cell phone.

15. A data backup system, comprising:
a cell phone, with a data to be backed up stored therein, the cell phone comprising:
an input module, for inputting a timing instruction; and
a timer, for receiving the timing instruction to calculate a predetermined time period and determining uninterruptedly whether the predetermined time period has elapsed; and
a storage device, for storing the data to be backed up, wherein when the timer determines that the predetermined time period has elapsed, the data to be backed up is stored in the storage device.

16. The data backup system according to claim 15, wherein the storage device is an extended memory capable of being installed in the cell phone.

17. The data backup system according to claim 16, wherein the extended memory is a memory card, an external hard disk, or a universal serial bus (USB) disk.

18. The data backup system according to claim 15, wherein the storage device is a network server.

19. The data backup system according to claim 15, further comprising:
a format converter, for performing a format conversion on the data to be backed up, so as to convert the data to be backed up into a data in a universal format and store the data in the universal format in the storage device.

20. The data backup system according to claim 19, further comprising:
an encryption unit, for encrypting the data in the universal format when performing the format conversion on the data to be backed up; and
a decryption unit, for decrypting the data in the universal format to convert the data in the universal format into a load data and storing the load data in the cell phone.

21. A data backup system, comprising:
a cell phone, with a data to be backed up stored therein, the cell phone comprising:
an input module, for inputting a timing instruction; and
a timer, for receiving the timing instruction to calculate a particular time point and determining uninterruptedly whether the particular time point is reached; and
a storage device, for storing the data to be backed up, wherein when the timer determines that the particular time point is reached, the data to be backed up is stored in the storage device.
